(19) United States
(12) Patent Application Publication
(10) Pub. No.: US 2024/0261864 A1
(43) Pub. Date: Aug. 8, 2024

(54) METHODS AND INSTALLATION FOR ADDITIVE MANUFACTURING OF A THREE-DIMENSIONAL METAL PART

(71) Applicant: Desktop Metal, Inc., Burlington, MA (US)

(72) Inventor: Maxime FAYOLLE, Saint-Etienne (FR)

(21) Appl. No.: 18/566,114

(22) PCT Filed: Jun. 3, 2022
(86) PCT No.: PCT/FR2022/051055

§ 371 Date: Dec. 1, 2023

(30) Foreign Application Priority Data
Jun. 3, 2021 (FR) FR2105847

(51) Int. Cl. B22F 12/63; B22F 10/14; B22F 10/37; B33Y 10/00; B33Y 30/00

(52) U.S. Cl. CPC B22F 12/63; B22F 10/14; B22F 10/37; B33Y 10/00; B33Y 30/00

(57) ABSTRACT

A process for 3D printing metal components involves providing a container of powdered metal material, providing a platform, employing a horizontally mobile feeding and compressing mechanism to dispense specified quantities of the metal material to create multiple layers, and subsequently compacting each of these layers. Additionally, a binder is applied to the surface of each layer. Furthermore, the feeding and compressing mechanism moves forward to establish a layer of the metal material and then retracts to compact the newly formed layer.

### CROSS-REFERENCE TO RELATED APPLICATIONS

This application is a U.S. National Stage Application of International Application No. PCT/FR2022/051055, filed on 3 Jun. 2022, and claims priority from French Patent Application No. FR 2105847, filed on 3 Jun. 2021; the disclosures of which are incorporated herein by reference.

### FIELD

The present disclosure relates to a method of additive manufacturing of a three-dimensional metal part and to an installation for implementing said method.

### BACKGROUND

Known additive manufacturing methods involve using a powdered metal material and preforming parts from this powdered metal material, by binding particles of the material together. The particles are then hot-sintered to consolidate the parts.

To this end, a device is implemented to laminate the powder material, and a plurality of layers of particles of said material are superimposed on a moving platform. The layers are deposited one on top of the other in succession, and a binder is printed on each of them in a predefined pattern in order to be able to locally bind the particles of the material of the layer together, and also the particles located at the interface with the underlying layer.

In this way, over the course of the layers, the part is designed in three dimensions, made of particles of the metal material bound together. The resulting part, known as a “green part”, is then stripped of the surrounding unbound particles and heated to high temperature. The bound metal particles then weld together to form the final part.

The quality of the final part depends on the compactness of the powder material layers. In fact, the more compact the powder material layers, the less occlusion there will be inside the final part, and the more mechanically resistant it will be.

It has also been devised to compact each of the layers by means of a roller. Document US 2020 038958 exactly shows a laminating device with two rollers, an upstream roller allowing to form the layer of powder material from a container of said material, and a downstream roller allowing to compact said layer.

A device of this type is relatively complex and leads to downtime between each lamination step. As a result, the “green parts” are produced with relatively modest productivity.

Therefore, a problem which arises and which the present disclosure aims to solve, is to provide an additive manufacturing method and installation, which make it possible to improve not only the productivity of the “green parts” produced, but also their quality.

### SUMMARY

According to a first object, a method of additive manufacturing of a three-dimensional metal part is proposed, comprising the following steps: a container containing a powdered metal material is provided; a platform is provided which is substantially horizontal and translationally movable along a vertical direction; a driving and compacting member is provided, mounted for translational movement along a horizontal direction, for being able to sequentially drive from said container to said platform a plurality of given quantities of said metal material to form a plurality of layers of said metal material, and for compacting each of said layers of said metal material, so as to superimpose a plurality of compacted layers of said metal material on said platform; a binder is printed in a predefined pattern on the surface of each of the compacted layers of said metal material, while said platform is lowered after each print; and said driving and compacting member is driven, for each of the quantities of said metal material, in a translational forward direction so as to form a layer of said metal material, and in a translational return direction to compact said formed layer.

Thus, one feature of the present disclosure lies in the implementation of a single driving and compacting member which, when translationally driven in a forward direction, drives the powdered metal material from the container towards the platform and helps to form a layer of the material, and when translationally driven in the return direction, compacts the layer which it helped to form in the forward direction. In other words, the forward and return movement of the single driving and compacting member enables the layer of material to be formed and compacted. In this way, with each translational movement, the driving and compacting member is operational, first to form the layer, then to compact it, without any further intermediate movement. As a result, there is no downtime, and compacted layers are produced more quickly.

The first layer is produced directly on the platform. It is then lowered to deposit the second layer, which is then compacted in turn.

After each forward and return round, the binder is printed on the surface of the last compacted layer, and the driving and compacting member is again translationally driven in the forward direction and then in the return direction. The platform is then lowered before the new forward and return round of the driving and compacting member.

According to one example of the present disclosure, said platform is raised before each driving of said driving and compacting member in the return direction. In other words, the platform is raised after the driving and compacting member has been translationally driven in the forward direction, and before it is translationally driven in the return direction. In this way, the uncompacted layer of powdered metal material is substantially raised, so that it is easier to compact when the driving and compacting member is translationally driven in the return direction.

This also increases the density and also the homogeneity of the compacted metal material layers. Consequently, their mechanical quality and strength are increased.

Advantageously, said platform is lowered by a first height distance before each driving of said driving and compacting member in the forward direction, and said platform is raised by a second distance less than said first distance before each driving of said driving and compacting member in the return direction. In this way, the platform is lowered after each addition of a further layer of compacted powder material, by a total distance equal to the thickness of the compacted layer.

According to one example of the present disclosure, said driving and compacting member is a rotating roller, and said rotating roller is rotationally driven in the same direction of rotation in the translational forward and return directions.

Thanks to the implementation of a rotating roller, the metal material is more easily conveyed from the container to the platform, and evenly distributed over the platform. And compacting in return is homogeneous.

In addition, said roller can be driven rotationally, so that said roller rolls each of said layers of said metal material in said return direction. In other words, the roller is rotationally driven in such a way that, when it is translationally driven in the forward direction, the tangential speed of the roller portion in contact with the powder material is oriented in a direction having a positive component with the forward driving direction of the roller. In this way, the powder material is distributed more uniformly over the previous compacted layer into an uncompacted layer of powder material.

When the roller is driven back and translationally in the opposite direction, but rotationally in the same direction as in the forward driving, it rolls the layer of uncompacted powder material. In other words, it performs its compaction.

According to another embodiment of the present disclosure, the driving and compacting member is an elastically deformable scraper, made, for example, from a polymer material. This type of driving and compacting member is of interest for certain categories of metal material and for certain grain sizes.

According to an example but by no means limiting embodiment of the present disclosure, said compacted layers of said metal material are caused to vibrate. For example, during each driving of the driving and compacting member in the return direction, the layers of powdered metal material are caused to vibrate. In this way, during compacting of the newly deposited new layer of material, the vibrations imposed on the material contribute to a reduction of the free volumes and consequently to better compacting. This also improves the homogeneity of the compacted layers, and hence the quality of the green parts.

Advantageously, said platform is vibrationally driven to cause the vibration of said compacted layers of said metal material. In this way, a better transmission and a better efficiency of the vibrations is obtained in the layer of powder material being compacted.

According to another object, an installation for additive manufacturing of a three-dimensional metal part is proposed, in order to implement the above-described manufacturing method. The installation comprises: a platform that is substantially horizontal and translationally movable along a vertical direction; a container located in the vicinity of said platform and containing a powdered metal material; a driving and compacting member mounted for translational movement along a horizontal direction for being able to sequentially drive a plurality of given quantities of said metal material from said container to said platform, for forming a plurality of layers of said metal material, and for compacting each of said layers of said metal material, so as to superimpose a plurality of compacted layers of said metal material on said platform; a printing device for printing a binder in a predefined pattern on the surface of each of said compacted metal material layers, while said platform is lowered after each print. The driving and compacting member is driven, for each of the quantities of said metal material, in a translational forward direction so as to form a layer of said metal material, and in a translational return direction to compact said formed layer.

Thus, by means of the aforementioned installation, the method of additive manufacturing of a three-dimensional metal part according to the present disclosure is implemented, as will be explained in greater detail in the following description.

Also, said platform is raised before each driving of said driving and compacting member in the return direction. The installation is equipped, for example, with a controllable hydraulic device allowing to drive the platform in motion and, in particular, for raising it.

In addition, said platform is lowered by a first height distance before each driving of said driving and compacting member in the forward direction, and it is raised by a second distance less than said first distance, before each driving of said driving and compacting member in the return direction. The installation includes, for example, command and control devices, enabling the platform to be driven sequentially, so that it is lowered before each forward trajectory of the driving and compacting member, and so that it is raised after the forward trajectory and before the return trajectory of the driving and compacting member.

According to one example of the present disclosure, said driving and compacting member is a rotating roller, and said rotating roller is rotationally driven in a same direction of rotation in the translational forward and return directions.

Furthermore, said roller is advantageously driven rotationally so that said roller rolls each of said layers of said metal material in said return direction. For this purpose, the installation comprises a motor unit adapted to be connected to the command and control devices, in order to be able to rotationally drive the roller as a function of the speed of the translational movement thereof.

According to another embodiment of the present disclosure, the driving and compacting member is an elastically deformable scraper, made, for example, from a polymer material. This type of driving and compacting member is of interest for certain categories of metal material and for certain grain sizes.

In addition, the installation comprises a cylindrical enclosure having an upper opening delimited by an enclosure edge, and said platform is translationally movable inside said enclosure. The platform is then adapted to be lowered below the level of the edge of the enclosure, so as to be able to receive the powder material in the form of a non-compacted layer, without risk of overflow. The platform can then be raised so that the uncompacted layer extends above the level of the edge of the enclosure, so as to be compacted by the returning driving and compacting member. The driving and compacting member can, for example, be supported on the two opposite edge portions of the enclosure.

Moreover, said container can have a container edge and said enclosure and said container are mounted substantially edge to edge. Consequently, the driving and compacting member is adapted to drive the powder material from the container towards the enclosure along a trajectory lying in a same plane. Advantageously, the edge of the container and the edge of the enclosure are connected to each other by a bridge, so as to facilitate the transfer of powder material from one to the other, and vice versa. In fact, one advantage of the installation according to one or more embodiments of the present disclosure is that any excess powder material can be reintroduced into the container after the compacting step. As a result, the powder material is well managed without loss or waste.

In addition, the installation comprises a vibrating device for causing vibration of said compacted layers of said metal material. Further, said vibrating device can be mounted integrally with said platform.

### BRIEF DESCRIPTION OF THE DRAWINGS

Further features and advantages of the present disclosure will become apparent from the following description of particular embodiments of the present disclosure, given by way of illustration but not limitation, with reference to the appended drawings in which:

FIG. 1 is a schematic view of the installation in a first state corresponding to a first phase of implementation of a manufacturing method according to an exemplary embodiment of the present disclosure;

FIG. 2 is a schematic view of the installation as illustrated in [FIG. 1] in a second state corresponding to a second phase of implementation of a manufacturing method according to an exemplary embodiment of the present disclosure;

FIG. 3 is a schematic view of the installation as illustrated in [FIG. 1] in a third state corresponding to a third phase of implementation of a manufacturing method according to one or more embodiments of the present disclosure;

FIG. 4 is a schematic view of the installation as illustrated in [FIG. 1] in a fourth state corresponding to a fourth phase of implementation of a manufacturing method according to one or more embodiments of the present disclosure;

FIG. 5 is a schematic view of the installation as illustrated in [FIG. 1] in a fifth state corresponding to a fifth phase of implementation of a manufacturing method according to one or more embodiments of the present disclosure;

FIG. 6 is a schematic view of the installation as illustrated in [FIG. 1] in a sixth state corresponding to a sixth phase of implementation of a manufacturing method according to one or more embodiments of the present disclosure; and,

FIG. 7 is a flow chart of the successive phases of implementation of an additive manufacturing method according to one or more embodiments of the present disclosure.

### DETAILED DESCRIPTION

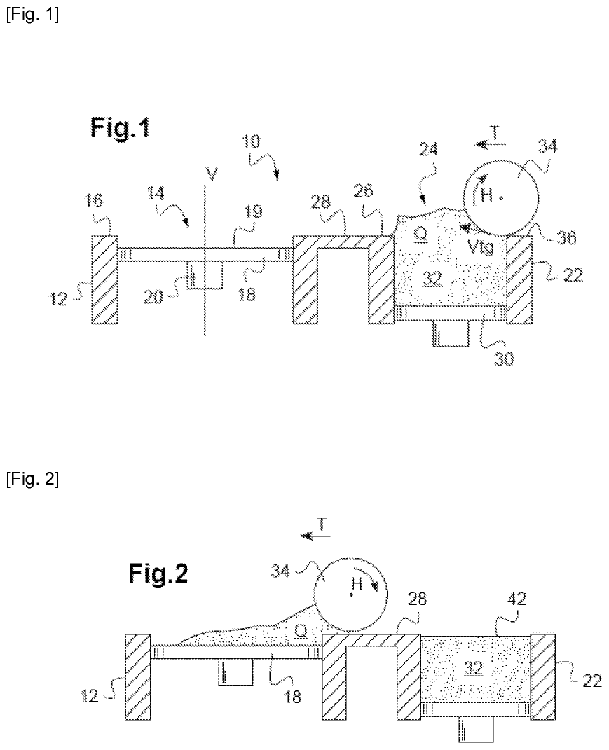

Schematically, [FIG. 1] shows an installation 10 for additive manufacturing of a metal part. It comprises a cylindrical enclosure 12, with a rectangular base, which has an upper opening 14 delimited by an enclosure edge 16. According to another embodiment, the cylindrical enclosure has a circular base. This geometry is more suitable for parts with cylindrical symmetry.

The installation 10 comprises a platform 18 mounted for translational movement along a vertical direction V inside the cylindrical enclosure 12. It has a flat receiving surface 19. Platform 18 extends horizontally and is adapted to be driven by hydraulic means comprising a controllable movable piston 20.

The installation 10 also comprises a container 22, adjoining the cylindrical enclosure 12. The container 22 has a container opening 24 delimited by a container edge 26, and the container edge 26 and enclosure edge 16 extend in a same plane. Furthermore, the cylindrical enclosure 12 and the container 22 are connected together edge to edge by a bridge 28.

The container 22 also comprises a bottom 30 which is translationally movable along a vertical direction.

The container 22 is then charged with a powdered metal material 32, and the movable bottom 30 allows the powder material to be driven in steps through the container opening 24. Thereby, given quantities of powder material can be brought above the level of the container edge 26 of the opening 24.

In addition, the installation comprises a rotating roller 34, made of a solid cylinder with a circular base. It has two opposite ends, advantageously bearing tangentially on two opposite transverse edge portions of the container 22. Also, in [FIG. 1], the roller 34 is resting on a free longitudinal edge portion 36 of the container 22.

In certain conditions, depending on the nature of the metal material and its grain size, it can be observed that the rotating roller can be replaced by an elastically deformable scraper, for example made of a polymer material.

The roller 34 is, as shown in [FIG. 1], rotationally driven in the clockwise direction H. It will be driven in this same direction during all steps of the manufacturing method according to one or more embodiments of the present disclosure.

In addition, the roller 34 is translationally movable along a direction parallel to the plane defined by the container 26 and enclosure edges 16. Also, the direction of movement of the roller 34 is substantially in a horizontal plane.

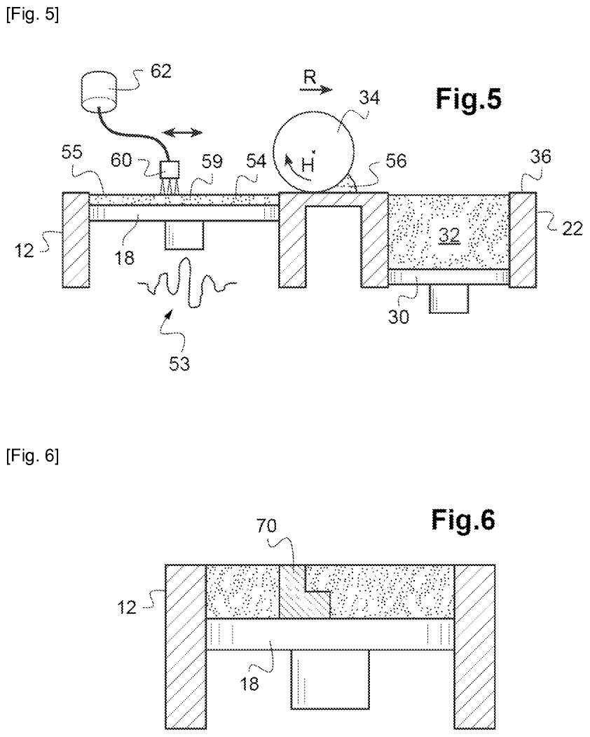

Other elements of the installation 10 will be described with reference to [FIG. 5].

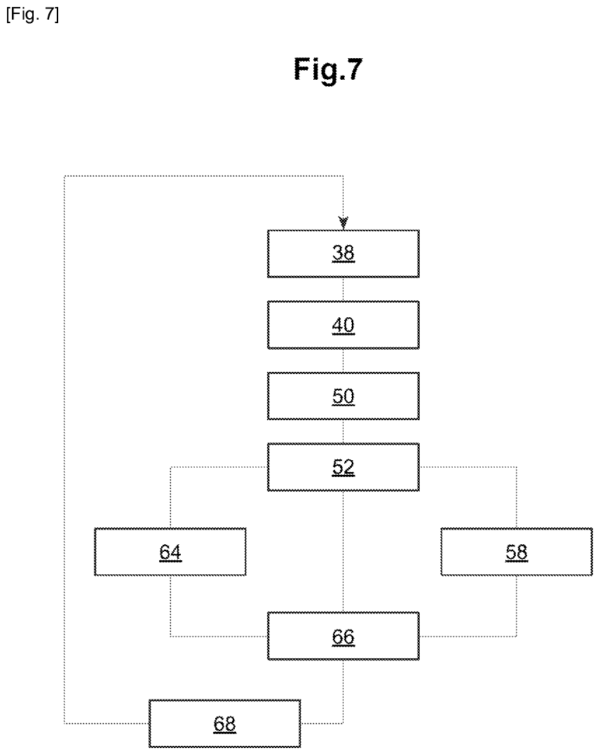

The sequence of steps of the method according to one or more embodiments of the present disclosure will now be described with reference to [FIG. 1] to [FIG. 6] and in support of the flow chart shown in [FIG. 7].

Thus, as illustrated in [FIG. 1], the platform 18 is adjusted inside the enclosure 12, so that its receiving surface 19 is adjusted to a predefined distance from the enclosure edge 16. This predefined distance determines a volume V delimited by the enclosure 12, the platform 18 and the plane of the enclosure edge 16.

In addition, the roller 34 is located in line with the first free longitudinal edge portion 36, and according to a first step 38, of the flow chart in [FIG. 7], the bottom 30 of the container 22 is driven vertically towards the container opening 24 to bring a quantity Q of powder material above the level of the container edge 26. This quantity 2 is determined as a function of the aforementioned volume V. Advantageously, the quantity Q is estimated to have a volume substantially less than the aforementioned volume V.

Next, the roller 34 is translationally driven in a forward direction, along a direction T towards the cylindrical enclosure 12, in accordance with a second step 40 of the method according to one or more embodiments of the present disclosure.

Therefore, as the roller 34 is rotationally driven in the clockwise direction H, the tangential speed Vtg of its parts in contact with the quantity Q of powder material is oriented in a direction having a positive component with the direction T of translation of the roller 34. As a result, the quantity of powder material is more easily driven by the roller 34.

Reference is made to [FIG. 2], where the roller 34, continuing its course according to the second step 40, has driven the quantity of powder material Q out of the container, onto the bridge 28 and partially into the cylindrical enclosure 12, onto the platform 18.

It will be observed that the powder material 32 inside the container 22 has a first flat surface 42 left downstream by the roller 34 and extending in the plane defined by the container edge 26.

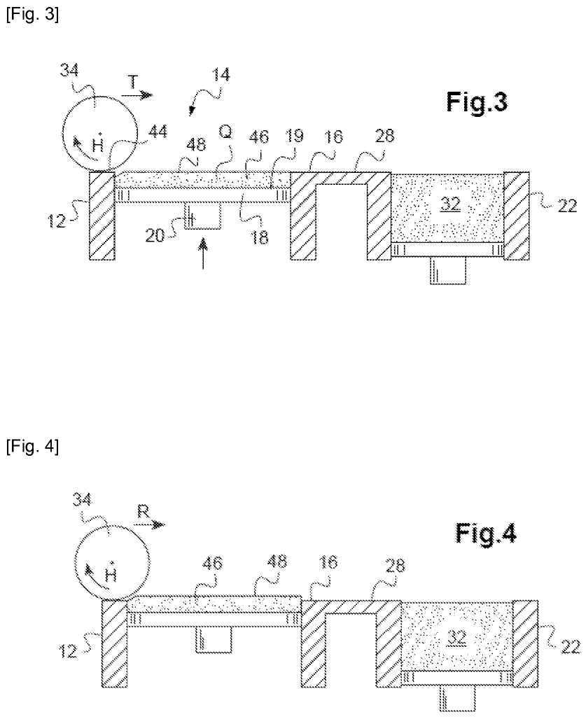

Continuing its course, the roller 34 reaches a free edge portion 44 of the enclosure 12, as shown in [FIG. 3]. Therefore, the quantity Q of powder material is distributed on the receiving surface 19 of the platform 18, and in the volume V defined by the relative position of the platform 18 and of the enclosure edge 16.

In this way, the quantity Q of powder material forms a first layer of powder material 46 of a substantially uniform thickness e1. The latter has a first layer surface 48, which extends substantially in the plane defined by the enclosure edge 16.

After the roller 34 has reached the free edge of the enclosure 44, according to a third step of the method according to one or more embodiments of the present disclosure, the platform 18 is driven vertically towards the upper opening of the enclosure 14, in order to raise the layer of powder material 46 by a distance p1 which is less than the thickness e1.

In this way, and as illustrated in [FIG. 4], the layer of powder material 46 then extends substantially to project from the enclosure edge 16. More precisely, it extends therefrom by a height equal to the distance p1.

In accordance with a fourth step 52 of the method according to one or more embodiments of the present disclosure, the roller 34 is then translationally driven in a return direction along a same direction, but in the opposite direction R, towards the container 22. The roller 34 is still rotationally driven along the clockwise direction H. As a result, the layer of powder material 46 is rolled and compacted to reduce the free spaces.

Advantageously, but not imperatively, a vibrating device 53 is installed on the platform 18 so as to be able to cause vibration of the layer of powder material 46 when it is compacted.

The vibrating device 53 can also be installed on the enclosure 12.

Continuing its course, the roller 34 as shown in FIG. 5 leaves behind a first compacted layer 54. The thickness of this first compacted layer 54, having a first compacted layer surface 55, is substantially equal to e1−p1.

By means of the vibrations, the free spaces are further reduced in the compacted layer 54 in addition to the rolling. Therefore, occlusions are reduced in the final part after and, sintering conversely, its mechanical strength is increased.

In addition, the roller 34 drives with it an excess of powder material 56 toward the container 22. This excess of powder material 56 can be recycled back into the container 22 without loss.

During the return of roller 34 in the return direction R, and after the first compacted layer 54 has been produced, a binder is printed according to a predefined pattern 59 in a fifth parallel step 58.

For this purpose, the installation comprises an injection head 60 connected to a binder container 62 and adapted to be driven movably along a plane parallel to the plane defined by the enclosure edge 16, and consequently parallel to the plane defined by the first compacted layer surface 55. The injection head 60 is adapted to be driven translationally along two perpendicular components to be able to inject the binder according to the predefined pattern.

The binder then diffuses through the first compacted layer 54 and binds together the particles of the powder material over the entire thickness of the layer and according to the predefined pattern 59.

Advantageously, during the fourth step 52, and before the roller 34 reaches the free longitudinal edge 36 of the container 22 when returning, the bottom 30 of the container 22 is lowered in a sixth step 64, so as to be able to accommodate the excess powder material 56 on the reserve of powder material 32.

When, at the end of its course, the roller 34 comes in line with the free longitudinal edge 36 of the container 22 in a seventh step 66, it has completed a first cycle.

Before starting a new cycle, the platform 18 is adjusted in an eighth step 68 inside the enclosure 12, so that the first compacted layer surface 55 is adjusted to the predefined distance from the enclosure edge 16, in order to be able to define the aforementioned volume V.

Thus, and according to the first step 38, the bottom of the container 22 is driven vertically towards the container opening 24 to bring a new quantity Q of powder material above the level of the container edge 26.

As illustrated in [FIG. 1], the roller 34 is then driven translationally in the forward direction, along the direction T towards the cylindrical enclosure 12 in accordance with the second step 40 of the method according to one or more embodiments of the present disclosure.

As illustrated in [FIG. 2] and [FIG. 3], the roller 34, continuing its course in accordance with the second step 40, has driven the quantity of powder material Q out of the container, onto the bridge 28 and into the cylindrical enclosure 12, onto the platform 18. It then has reached the free edge portion 44 of the enclosure 12. As a result, the quantity Q of powder material is distributed over the first compacted layer surface 55 in the volume V defined by the relative position of the platform 18 and the enclosure edge 16.

In this way, the quantity Q of powder material forms a second layer of powder material, not shown, of a substantially uniform thickness e2. It has a second layer surface which extends in the plane defined by the enclosure edge 16.

When the roller 34 has reached the free edge of the enclosure 44, according to the third step of the method according to one or more embodiments of the present disclosure, the platform 18 is driven vertically towards the upper opening of the enclosure 14 in order to raise it by a distance p2, equal to p1 and less than the thickness e2 of the powder material layer.

In this way, the powder material layer extends to project from the enclosure edge 16 by a height equal to the distance p2.

According to the fourth step 52 of the method according to one or more embodiments of the present disclosure, the roller 34 is then driven translationally in the return direction according to the direction R, towards the container 22. The roller 34 is still driven rotationally along the clockwise direction H, and the layer of powder material is rolled, thereby compacting it and reducing the free spaces.

Advantageously, vibration of the layer of powder material is also caused as it is compacted.

In this way, the roller 34 as shown in [FIG. 5] leaves behind a second compacted layer. The thickness of this second compacted layer, presenting a second compacted layer surface, is substantially equal to e2−p2.

During the return of the roller 34 in the return direction R, and after the second compacted layer has been produced, the binder is printed according to the predefined pattern 59 in the fifth parallel step 58.

The binder then diffuses not only through the second compacted layer 54 to bind together the particles of powder material over the entire thickness of the layer, but also, at the interface between the two compacted layers to be able to bind together the particles of powder material at the interface.

The steps of the above-mentioned method are thus repeated as many times as necessary in order to be able to bind together particles of powder material layer by layer and between layers according to a predefined pattern, to thereby achieve a green part 70 as shown in [FIG. 6].

The green part 70 thus produced is homogeneous in that the bound powder material particles are distributed uniformly throughout the body of the part. In addition, thanks to the high compacting of the powder material layers, the part has very little free space.

Consequently, once the green part 70 has been extracted from the surrounding free particles of powder material, it is transferred to a furnace for sintering. Thanks to the process according to one or more embodiments of the present disclosure, the part then obtained has very few occlusions. In addition, its mechanical strength is thus increased.

What is claimed is:

1. A method of additive manufacturing of a three-dimensional metal part comprising:
providing a container containing a powdered metal material;
providing a platform which is substantially horizontal and translationally movable along a vertical direction;
providing a driving and compacting member, mounted for translational movement along a horizontal direction;
driving, by the driving and compacting member, sequentially from said container to said platform a plurality of given quantities Q of said metal material to form a plurality of layers of said metal material;
compacting, by the driving and compacting member, each of said layers of said metal material, so as to superimpose a plurality of compacted layers of said metal material on said platform;
printing a binder in a predefined pattern on a surface\of each of the compacted layers of said metal material, comprising lower said platform after each print;
wherein said driving and compacting member is driven, for each of the quantities Q of said metal material, in a translational forward direction so as to form a layer of said metal material, and in a translational return direction to compact said formed layer.

2. The manufacturing method according to claim 1,
wherein said platform is raised before each driving of said driving and compacting member in a return direction.

3. The manufacturing method according to claim 2,
wherein said platform is lowered by a first height distance before each driving of said driving and compacting member in the forward direction, and
wherein said platform is raised by a second distance less than said first distance before each driving of said driving and compacting member in the return direction.

4. The manufacturing method according to claim 1,
wherein said driving and compacting member is a rotating roller, and
wherein said rotating roller is rotationally driven in a same direction of rotation in the translational forward and return directions.

5. The manufacturing method according to claim 4,
wherein the roller is rotationally driven in such a way that, when it is translationally driven in the forward direction, the tangential speed of the portion of the roller in contact with the powder material is oriented in a direction having a positive component with the forward driving direction of the roller.

6. The manufacturing method according to claim 4,
wherein said roller is rotationally driven so that said roller rolls each of said layers of said metal material in said return direction.

7. The manufacturing method according to claim 1, further comprising
causing vibration of said compacted layers of said metal material.

8. The manufacturing method according to claim 7,
wherein said platform is vibrationally driven to cause vibration of said compacted layers of said metal material.

9. An installation for additive manufacturing of a three-dimensional metal part, the installation comprising:
a substantially horizontal platform translationally movable along a vertical direction;
a container located in the vicinity of said platform and containing a powdered metal material;
a driving and compacting member mounted for translational movement along a horizontal direction for being configured to sequentially drive a plurality of given quantities Q of said metal material from said container to said platform, for forming a plurality of layers of said metal material, and for being configured to compact each of said layers of said metal material, so as to superimpose a plurality of compacted layers of said metal material on said platform;
a printing device for printing a binder in a predefined pattern on the surface of each of said compacted metal material layers, while said platform is lowered after each print;
wherein said driving and compacting member is configured to be driven, for each of the quantities Q of said metal material, in a translational forward direction so as to form a layer of said metal material, and in a translational return direction to compact said formed layer.

10. The installation according to claim 9, wherein said platform is configured to be raised before each driving of said driving and compacting member in a return direction.

11. The installation according to claim 10, wherein said platform is configured to be lowered by a first height distance before each driving of said driving and compacting member in the forward direction, and in that it is configured to be raised by a second distance less than said first distance before each driving of said driving and compacting member in the return direction.

12. The installation according to claim 11, wherein said driving and compacting member is a rotating roller, and in that said rotating roller is configured to be rotationally driven in a same direction of rotation in the translational forward and return directions.

13. The installation according to claim 12, wherein said roller is configured to be rotationally driven so that said roller is configured to rolls each of said layers of said metal material in said return direction.

14. The installation according to claim 8, further comprising a cylindrical enclosure having an upper opening delimited by an enclosure edge, and
wherein said platform is translationally movable inside said enclosure.

15. The installation according to claim 14,
wherein said container has a container edge and wherein said enclosure and said container are mounted substantially edge to edge.

16. The installation according to claim 9, further comprising a vibrating device for causing vibration of said compacted layers of said metal material.

17. The installation according to claim 16,
wherein characterized said vibrating device is mounted integrally with said platform.
